(19) United States
(12) Patent Application Publication
(10) Pub. No.: US 2012/0273309 A1
(43) Pub. Date: Nov. 1, 2012

(54) AIRCRAFT BRAKING SYSTEM ARCHITECTURE

(75) Inventors: Julien THIBAULT, Gif Sur Yvette (FR); Stéphane Mudry, Lyon (FR); Dominique Onfroy, Saint-Cloud (FR)

(73) Assignee: MESSIER-BUGATTI-DOWTY, Velizy-Villacoublay (FR)

(21) Appl. No.: 13/441,580

(22) Filed: Apr. 6, 2012

(30) Foreign Application Priority Data
Apr. 7, 2011 (FR) 11 53032

(51) Int. Cl. B64C 25/44

(52) U.S. Cl. 188/158

(57) ABSTRACT

An aircraft braking system architecture having brakes with electromechanical actuators (3) for selectively applying a braking force to respective stacks of disks (2) in order to exert a braking torque on respective wheels. Included is at least one power module (7) that sends phase currents to the electromechanical actuators so that the latter can exert a braking force and at least one control module (8) for controlling the power module in response to a braking command such that appropriate phase currents are sent to the actuators so that these can develop the desired braking force. At least one power supply unit (20), comprising means (21) of generating a high voltage (HVDC), supplies the power module with the high power it needs for powering the actuators. The unit (20) also has means (22) for generating a low voltage (LVDC) for powering at least the control module at a low voltage.

The invention relates to an aircraft braking system architecture.

### TECHNICAL BACKGROUND OF THE INVENTION

Aircraft braking systems comprising:
brakes with electromechanical actuators for selectively applying a braking force to respective stacks of disks in order to exert a braking torque on respective wheels;
at least one power module designed to send phase currents to the electromechanical actuators so that the latter can exert a braking force;
at least one control module for controlling the power module in response to a braking command such that appropriate phase currents are sent to the actuators so that these can develop the desired braking force;
at least one power supply unit comprising means of generating a high voltage from an electric power bus of the aircraft and/or from a battery of the aircraft, to supply the power module with the high power it needs for powering the actuators,
are known.

In general, the control module and the power module are grouped together in a controller known as an EMAC. The power supply unit generally comprises a converter (for example a transformer) capable of transforming the power supplied by the aircraft power bus into a high-voltage power calibrated to meet the high-power demands generated by the power module of the EMAC.

The electronic boards in the control module of the EMAC are themselves powered by a low-voltage source of the aircraft. Furthermore, the EMAC generally incorporates the control for a member that locks the electromechanical actuator in position, which is used as a parking brake, and which can be powered at a low voltage or at a high voltage in order to actuate it.

Finally, the architecture generally comprises a braking computer designed to generate the braking command (AUTOBRAKE function), applying protection against slippage. The electronic boards in the computer are powered by the low-voltage source of the aircraft.

### OBJECT OF THE INVENTION

The invention seeks to provide a simplified braking system architecture that requires fewer connections to the electrical systems of the aircraft.

### INTRODUCTION TO THE INVENTION

In order to achieve this goal, the invention proposes an aircraft braking system architecture comprising:
brakes with electromechanical actuators for selectively applying a braking force to respective stacks of disks in order to exert a braking torque on respective wheels;
at least one power module designed to send phase currents to the electromechanical actuators so that the latter can exert a braking force;
at least one control module for controlling the power module in response to a braking command such that appropriate phase currents are sent to the actuators so that these can develop the desired braking force;
at least one power supply unit comprising means of generating a high voltage to supply the power module with the high power it needs for powering the actuators.

According to the invention, the power supply unit further comprises means for generating a low voltage for powering at least the control module at a low voltage.

The low voltage thus generated is used both to power the electronic boards of the control module and to actuate the member that locks the actuators used as a parking brake if the actuators are so equipped. Further, this low voltage may be used also for powering the braking computer or computers if the braking system is so equipped. Thus, connecting the braking system of the invention to the power sources of the aircraft will be reduced to connecting the power supply unit to the power bus of the aircraft or to the battery thereof. All the other items of equipment in the braking system will be powered directly by the power supply unit, and this considerably simplifies the connecting of the braking system to the power sources of the aircraft.

According to one particular aspect of the invention, the power supply unit is equipped with a controlled power switch positioned downstream of the means of generating high voltage. This switch is a safety feature that guarantees that the high voltage will be delivered to the actuators only if a braking command is delivered, this making it possible to prevent unwanted brakings. It may, for example, be controlled using the logic set out in detail in document FR 2 857 642.

According to another particular aspect of the invention, instead of, or as well as, being equipped with the power switch already mentioned, the power supply unit is equipped with a controlled switch positioned downstream of the means of generating low voltage. This switch guarantees that the control module will be powered, and therefore capable of commanding the power module to generate phase currents, only if a braking command has been delivered, and this likewise prevents unwanted brakings.

### BRIEF DESCRIPTION OF THE DRAWINGS

The invention will be better understood in the light of the description which follows of some particular embodiments of the invention given with reference to the figures of the attached drawings among which:

FIG. 1 is a diagram of an aircraft braking system according to one particular embodiment of the invention; and

FIG. 2 is a diagram illustrating an alternative form of the braking system illustrated in FIG. 1.

In these figures, flows of high voltage are depicted in bold line, flows of low voltage in fine line, and flows of signals in chain line.

### DETAILED DESCRIPTION OF THE INVENTION

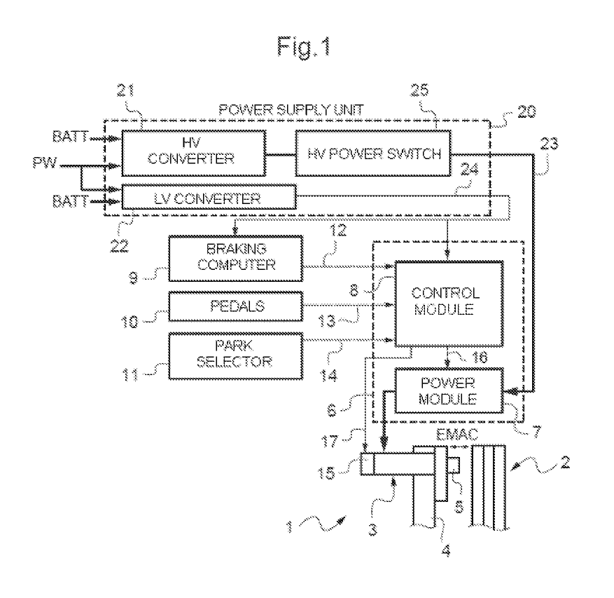

With reference to FIG. 1, the electromechanical brakes 1 of the aircraft braking system of the invention each comprise a stack of disks 2 comprising, in alternation, disks that rotate as one with the wheel that is to be braked and disks which do not rotate. Each brake 1 comprises a plurality of actuators 3 (just one is depicted here) which are carried by a ring 4 so that they lie facing the stack of disks 2. Each actuator 3 comprises a plunger 5 that can be moved toward the pile of disks 2 in order to press it and thus generate a braking force.

The plunger 5 is moved by an electric motor of the actuator via a drive line which converts a rotational movement of the electric motor into a translational movement of the plunger 5. The electric motor is powered via a controller or EMAC 6 comprising a power module 7 which delivers to the motor of the actuator phase currents dependent on a command 16 delivered by a control module 8.

The commands delivered by the control module 8 are formulated on the basis of various signals originating in particular from a braking computer 9, a brake pedal 10 or a park selector 11.

The entire braking system of the aircraft is designed here to operate in three modes: a normal mode, an emergency mode, and a parking mode.

In the normal mode, the control module 8 generates a command 16 on the basis of a braking instruction 12 received from the braking computer 9.

In the emergency mode, in which the braking computer is defective, the control module 8 generates a command 16 on the basis of a pedal signal 13 representative of the depressing of the brake pedal 10 which is actuated directly by the pilot.

In the parking mode, which takes priority over the other modes, the control module 8 generates a parking braking command 17 in response to a parking signal 14 emitted when the parking selector 11 is actuated by the pilot. In order to allow parking braking to be sustained while the aircraft is stationary, the actuator 3 is equipped with a parking locking member, here for example a no-current brake 15 which, when not supplied with power, locks the plunger in position by locking one of the transmission shafts of the drive train between the electric motor and the plunger 5.

All that is then required is to ensure that the no-current brake 15 is powered, to command the movement of the plunger 5 so that it exerts a parking force on the stack of disks, and then to cut off the power supply to the no-current brake 15 so that the actuator is locked in the parking brake position.

The architecture comprises a power supply unit 20 incorporating converters 21 and 22 which, on the basis of at least one aircraft power bus PW and, where appropriate, the aircraft battery, produce powers (in this instance DC currents) used to power the various items of equipment of the braking system, these respectively being a high voltage HVDC 23 and a lower voltage LVDC 24.

Of course a converter is to be understood to mean any device which, from the power sources available (for example the alternators driven by the jet engines or by the aircraft auxiliary power unit), makes it possible to generate the two powers needed for the operation of the braking system. For preference, each converter includes a controlled switch making it possible to switch over to the aircraft battery when the power sources are no longer available.

The high voltage HVDC 23 is used to power the power module 7 of the EMAC 6 so that the latter can generate the phase currents needed to power the brake actuator motors. The low voltage LVDC 24 itself powers the control module of the EMAC 6, and the braking computer 9 and is used to supply the electricity needed for the operation of the associated electronic boards. Thus, only the power supply unit 20 is connected to the power sources of the aircraft.

Here, a controlled power switch 25 is positioned downstream of the high voltage converter 21 in order to allow the power module of the EMAC to be supplied with power only if a braking command has indeed been issued, either by the braking computer, or by the pedals, or by the park selector.

The control logic for the power switch 25 may for example be as per the logic detailed in document FR 2 857 642.

This logic by default positions the switch 25 in an open position for which the power module of the actuator 7 is not supplied with power. In this position, the plunger 5 of the actuator 3 cannot move in response to a command from the control module 8. This logic positions the switch 25 in a closed position only in response to a closure command originating from the actuator control module 8, confirmed by a confirmation signal not originating from the control module 8 and independent thereof.

The advantages of the provisions of the invention are many:
Improved availability of braking capability. With a power supply unit according to the invention, it is possible to brake the airplane without the airplane power network being available (with all the jet engines and auxiliary power units switched off and with no external power supply available) because the power supply unit is able automatically from the battery to manage the supply of high and low voltage to the equipment items of the braking system.
Simplified braking system, achieved by limiting the number of voltage converters in the braking system and the number of power supply inputs for the various items of equipment in the braking system. Furthermore, the power supply unit can be programmed simply to reset the various items of equipment through an operation of cutting and then resupplying the power to the associated boards.
Improved reliability of the braking system. The reliability of the items of equipment that make up the braking system is appreciably increased because the power supply unit can be programmed to shut down the various items of equipment of the braking system during phases of flight, with the landing gear up, and allow power to be supplied to them only as the landing gear is deployed.
Optimized battery consumption. In the event of a switch over to the aircraft battery, the low voltage can be authorized only when there is a demand for braking, in order to limit battery consumption. A copy of the battery status can be sent by the power supply unit to the actuator control modules and computers in order to lighten the control laws (degraded braking performance using the battery is generally permitted by the aircraft manufacturer).
Improved transparency of the braking system. When the shutdown commands are issued, the power supply unit can manage the transparency necessary for the computers it powers, in order to log data or sustain power supplies to parking devices for example.

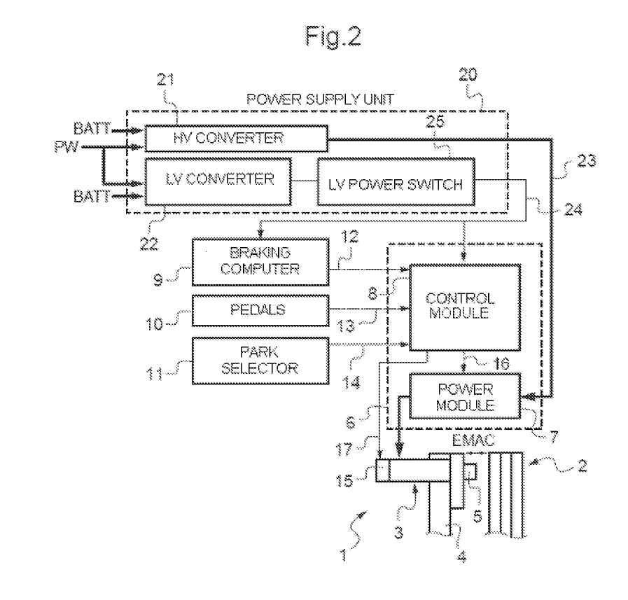

According to an alternative form of embodiment illustrated in FIG. 2, it is permissible, instead of (or as well as) having the power switch 25 arranged on the high voltage power supply line, to provide a switch 25′ arranged on the low voltage power supply line. The switch 25′ is controlled in such a way that it closes if a braking command is generated, remaining open in other cases, in order to prevent any risk of unwanted braking. Indeed, rather than depriving the power module of high voltage, thus preventing the actuators from applying any braking force whatever, the new switch deprives the control module of low voltage, thus preventing the control module from formulating the instructions necessary for the power module to power the actuators. The effect is therefore the same, but the new switch 25′ is of course of a smaller size and therefore less heavy and less bulky.

As an alternative, the switch 25′ could be left by default in the closed position and be opened in response to a command to shut down the equipment, or in aircraft operating phases that do not require braking (for example in response to detection that the landing gear is up in the landing gear bay).

Of course the invention is not restricted to that which has just been described, but more generally encompasses any alternative form that falls within the scope defined by the claims.

In particular, although the control module and the power module here are depicted as being physically grouped together into one and the same controller or EMAC, these two modules could be separate. Thus, the control module could, for example, be incorporated into the braking computer, whereas the power module could be positioned as close as possible to the braking actuators.

Further, although the presence of a controlled power switch in the power supply unit makes it possible to prevent unwanted braking, such a switch could be omitted if other safety features elsewhere allow such events to be avoided.

The means for generating low voltage in the power supply unit can work off various power sources:
an aircraft power bus (high or low AC or DC voltage available with the alternators driven by the engines, the APU, an external power supply, etc.);
the aircraft battery, or an internal battery of the power supply unit, this source normally being always available;
the high voltage generated by the power supply unit itself.

Finally, the power supply unit of the invention could be equipped with an internal power source, for example a dedicated battery, designed to take over from the power bus and from the batteries of the aircraft if these fail or become unavailable.

1. Aircraft braking system architecture comprising:
brakes with electromechanical actuators (3) for selectively applying a braking force to respective stacks of disks (2) in order to exert a braking torque on respective wheels;
at least one power module (7) designed to send phase currents to the electromechanical actuators so that the latter can exert a braking force;
at least one control module (8) for controlling the power module in response to a braking command such that appropriate phase currents are sent to the actuators so that these can develop the desired braking force;
at least one power supply unit (20) comprising means (21) of generating a high voltage (HVDC) to supply the power module with the high power it needs for powering the actuators;
characterized in that the power supply unit further comprises means (22) for generating a low voltage (LVDC) for powering at least the control module at a low voltage.

2. Braking system architecture according to claim 1, in which the means (22) of generating a low voltage also power a braking computer (9) designed to deliver a braking command to the control module.

3. Braking system architecture according to claim 1, in which the power supply unit (20) is equipped with a controlled switch (25) positioned downstream of the means (21) of generating high voltage (HVDC) and switched into a closed position in response to a braking command delivered to the control module (8).

4. Braking system architecture according to claim 1, in which the power supply unit (20) is equipped with a controlled switch (25′) positioned downstream of the means (22) of generating low voltage (LVDC) and switched into a closed position in response to a braking command delivered to the control module (8).
